(19) United States
(12) Patent Application Publication
(10) Pub. No.: US 2026/0128538 A1
(43) Pub. Date: May 7, 2026

(54) TWO-PIECE RIGHT ANGLE MALE TERMINAL FOR A HEADER ASSEMBLY OF AN ELECTRICAL CONNECTOR, AND THE ELECTRICAL CONNECTOR THEREOF

(71) Applicant: Molex, LLC, Lisle, IL (US)

(72) Inventors: Muttanna Belle, Bangalore (IN); Harsha Thyagaraj, Bangalore (IN)

(21) Appl. No.: 19/117,400

(22) PCT Filed: Nov. 22, 2023
(86) PCT No.: PCT/IB2023/061815

§ 371 Date: Apr. 1, 2025

(30) Foreign Application Priority Data
Nov. 25, 2022 (IN) 202241067885

(51) Int. Cl. H01R 12/71; H01R 12/58; H01R 12/70; H01R 13/11; H01R 13/405; H01R 13/50; H01R 13/621; H01R 43/24; H01R 43/26

(52) U.S. Cl. CPC H01R 12/716; H01R 12/58; H01R 12/7047; H01R 12/707; H01R 13/111; H01R 13/405; H01R 13/50; H01R 13/621; H01R 43/24; H01R 43/26

(57) ABSTRACT

A right angle male terminal of an electrical connector has first and second separate pins which are press fit together to form an interference fit. One pin has an unthreaded socket and the pin has A mating projection of one pin is coupled to a socket of the other pin by an interference fit, and axial centerlines of the pins are perpendicular. This structure optimizes flatness and hole true position, provides electrical stability, and eliminates issues resulting from material squeezing and/or material expansion.

### RELATED APPLICATIONS

This application claims priority to Indian Provisional Application No. 202241067885 filed Nov. 25, 2022, which is incorporated herein by reference.

### FIELD OF THE DISCLOSURE

This disclosure generally relates to a right angle male terminal for a header assembly of an electrical connector.

### DESCRIPTION OF RELATED ART

Connectors, such as high-current wire-to-board/wire-to-busbar connectors for high power applications for computers, data servers, busbar applications, etc., use a header assembly having right angle terminals to provide connections between the wires and the circuit board/busbar. Electrical contact occurs between the male terminal and the substrate of the circuit board. In a surface mounting coupling, a tail portion of the male terminal is soldered to a conductive contact pad on the surface of the circuit board. In a through hole coupling, the tail portion of the male terminal extends through a hole in the circuit board and is electrically coupled to conductive material in the hole by soldering. In a screw mounting assembly, threaded shank of a screw is threaded into the tail portion of the male terminal from a second side of the circuit board, and a washer, which may a flat washer or a Belleville washer, is positioned between the circuit board and an enlarged head of the screw.

As shown in the FIGS. 21 and 22, it is known to bend a solid elongated cylindrical rod to form the right angle terminal 2. Prior to bending, the solid rod has opposite ends which define a centerline of the rod. The solid rod is bent in an area of bending portion to form the right angle terminal 2. In an ideal situation, the solid rod is bent to exactly 90 degrees such that centerlines 4a, 6a of a resulting wire connecting portion 4 and tail portion 6 of the male terminal 2 are perpendicular to each other. The tail portion 6 may have an enlarged portion 8 proximate to its end. The male terminal 2 is insert molded into a header of a header assembly. The wire connecting portion 4 is within the header and the tail portion 6 extends downward from the header for connection to a circuit board 16. When a larger diameter rod is bent or when a shorter length of tail portion 6 is provided in this process, electrical performance problems may result in the resulting connector as a result of the following considerations.

In the area of bending, the material on an inner side of the solid rod (material squeezing area SA, see FIG. 21) is squeezed along the internal bend radius as a result of compression. The squeezed material can bulge from the cylindrical shape as shown in FIG. 23. In addition, as a result of bending the solid rod, the material on an outer side (material expansion area EA, see FIG. 21) along the external bend radius expands as a result of tension. This can cause a crack in the outer side of the resulting terminal because of microstructure movements. These affect the electrical performance of the resulting terminal.

In addition, an important consideration to provide proper electrical contact in a surface mounting coupling is that a flat planar end 10 formed as part of the tail portion 6 sits flush against a planar surface 20 of the circuit board 16. This eliminates any air gaps which would impact the electrical performance. In the known bending of the solid rod, because of springback that occurs during bending, the centerline 6a of the tail portion 6 and the planar surface 20 of the circuit board 16 are often not completely perpendicular to each other such s point contact 12 between the flat planar end 10 and the planar surface 20 forms such that an air gap 6 also arises. This can lead to improper electrical contact between the planar surface 10 of the tail portion 6 and the planar surface 20 of the circuit board 16, which may result into higher resistance to current transfer and higher heat generation because of the reduced surface contact. The same issues impact electrical performance in a through hole coupling because the tail portion 6 may be tilted relative to a central axis 22a of the through hole 22, thereby compromising the electrical performance.

### BRIEF DESCRIPTION OF THE DRAWINGS

The present disclosure is illustrated by way of example, and not limited, in the accompanying figures in which like reference numerals indicate similar elements.

FIG. 1 depicts a bottom perspective view of an electrical connector according to a first embodiment mounted onto a circuit board;

FIG. 2 depicts an exploded perspective view of the electrical connector and the circuit board;

FIG. 3 depicts a side elevation view of a two-piece right angle male terminal which forms part of the electrical connector and shown mounted onto the circuit board;

FIG. 4 depicts an exploded side elevation view of the two-piece right angle male terminal;

FIG. 5 depicts an end elevation view of the two-piece right angle male terminal;

FIG. 6 depicts a cross-sectional view of a header assembly of the electrical connector having the two-piece right angle male terminal therein and mounted on the circuit board;

FIG. 7 depicts a cross-sectional view of the electrical connector having the two-piece right angle male terminal mounted therein and mounted on the circuit board;

FIG. 8 depicts a bottom perspective view of an electrical connector according to a second embodiment mounted onto a circuit board;

FIG. 9 depicts a side elevation view of a two-piece right angle male terminal which forms part of the electrical connector of FIG. 8, and shown mounted onto the circuit board;

FIG. 10 depicts an exploded side elevation view of the two-piece right angle male terminal of FIG. 9;

FIG. 11 depicts an end elevation view of the two-piece right angle male terminal of FIG. 9;

FIG. 12 depicts a cross-sectional view of a header assembly of the electrical connector of FIG. 8 having the two-piece right angle male terminal therein and mounted on the circuit board;

FIG. 13 depicts a side elevation view of a two-piece right angle male terminal which forms part of an electrical connector according to a third embodiment;

FIG. 14 depicts a perspective view of a pair of the two-piece right angle male terminals of FIG. 13;

FIG. 15 depicts perspective view of a header assembly of the electrical connector according to the third embodiment and having the two-piece right angle male terminals of FIG. 13 therein;

FIG. 16 depicts an end elevation view of the header assembly of FIG. 15;

FIG. 17 depicts a side elevation view of a two-piece right angle male terminal which forms part of an electrical connector according to a fourth embodiment;

FIG. 18 depicts a perspective view of a pair of the two-piece right angle male terminals of FIG. 17;

FIG. 19 depicts perspective view of a header assembly of the electrical connector according to the fourth embodiment and having the two-piece right angle male terminals of FIG. 17 therein;

FIG. 20 depicts an end elevation view of the header assembly of FIG. 19;

FIG. 21 depicts a cross-sectional elevation view of a prior art male terminal shown exploded from a circuit board;

FIG. 22 depicts an end elevation view of the prior art male terminal shown mounted onto the circuit board; and

FIG. 23 depicts a perspective view of the prior art male terminal and an enlargement of a portion thereof.

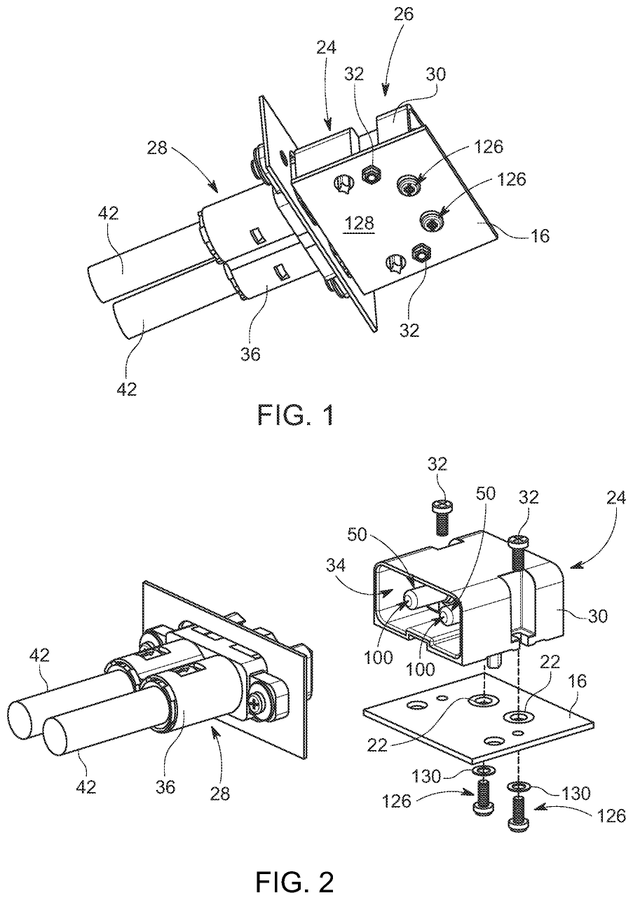

The drawings illustrate an embodiment of the present disclosure and it is to be understood that the disclosed embodiment is merely exemplary of the disclosure, which may be embodied in various forms. Therefore, specific details disclosed herein are not to be interpreted as limiting, but merely as a basis for the claims and as a representative basis for teaching one skilled in the art to variously employ the present disclosure.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

The present disclosure is illustrated by way of example, and not limited, in the accompanying figures in which like reference numerals indicate similar elements and in which, the appended figures illustrate features of embodiments of a terminal of a header assembly.

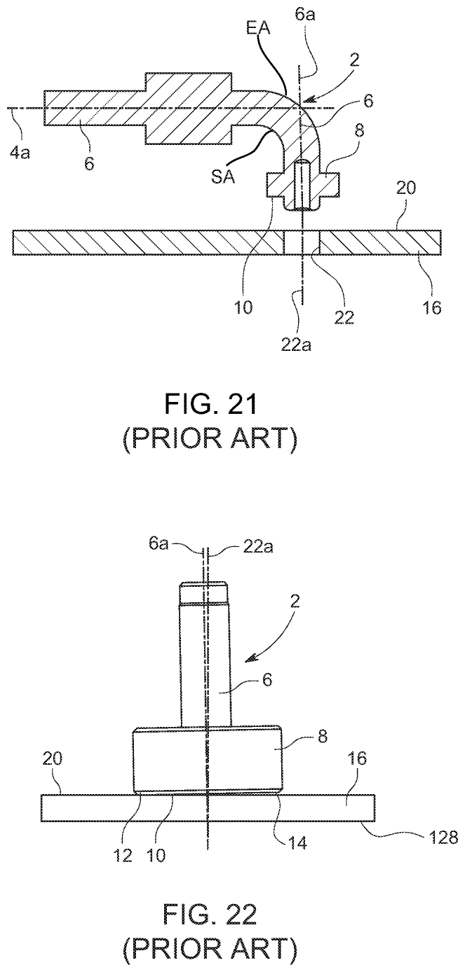

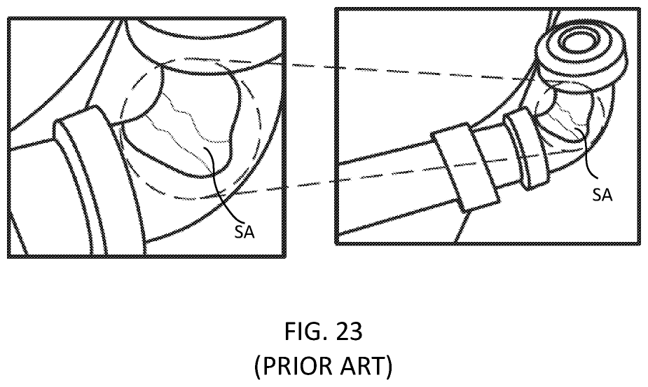

The present disclosure is directed to a two-piece right angle male terminal 100, 200, 300, 400 for use in a header assembly 24 of an electrical connector 26 which overcomes the issues which occur when a single solid rod is bent to form the right angle terminal as done in the prior art shown in FIGS. 21 and 22. The male terminal 100, 200, 300, 400 is conductive. This design is particularly suited for forming a 3.4 mm terminal, a 6 mm terminal, an 8 mm terminal, an 11 mm terminal, and a 15 mm terminal.

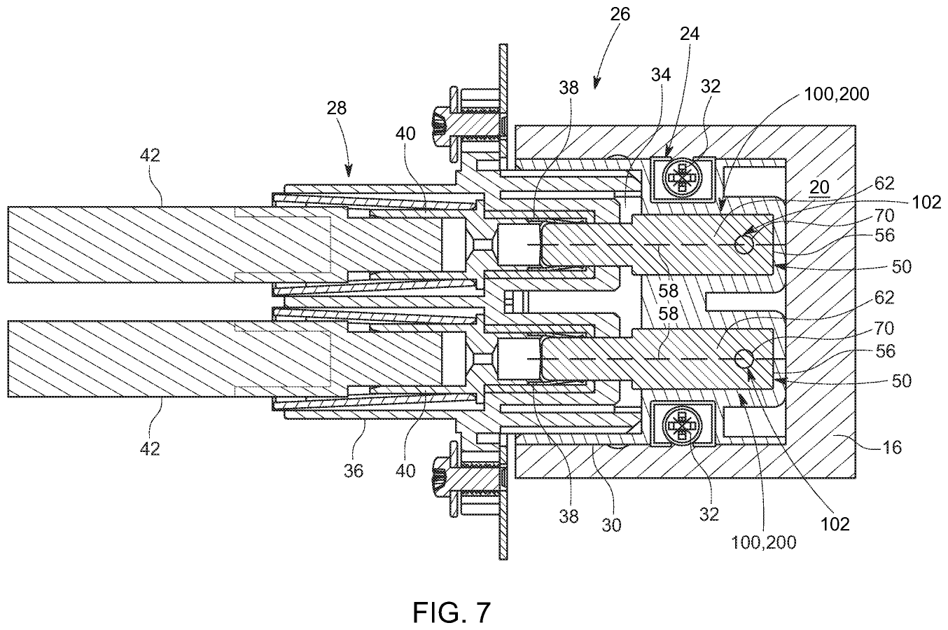

The electrical connector 26 includes the header assembly 24 and a receptacle 28 which are releasably coupled together. The header assembly 24 includes a housing 30 which is coupled to the circuit board 16 for example by fasteners 32. Male terminals 100, 200, 300, 400 are insert molded into the housing 30 and open into a cavity 34 of the housing 30. The male terminals 100, 200, 300, 400 may be formed from copper alloy. The receptacle 28 includes a housing 36 having a plurality of passageways therethrough. A conductive socket 38 having flexible contact beams seats within each passageway at a front end thereof, see FIG. 7. A conductive wire coupler 40 seats within each passageway rearward of the respective socket 38 and is electrically coupled thereto. A wire 42 is electrically coupled to each wire coupler 40.

When the header assembly 24 and receptacle 28 are coupled together, the housing 36 of the receptacle 28 seats within the cavity 34 of the header assembly 24. The male terminals 100, 200, 300, 400 enter into respective passageways and engage the contact beams of the socket 38. As a result, the wires 42 are electrically coupled to the male terminals 100, 200, 300, 400.

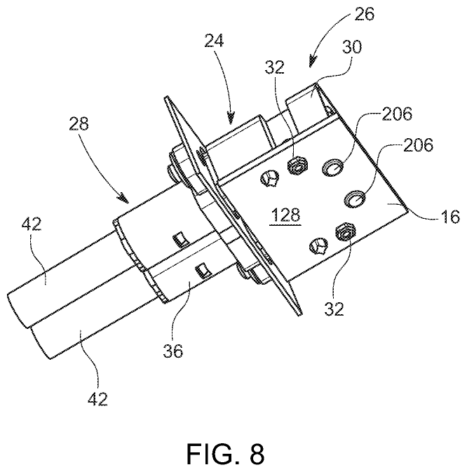

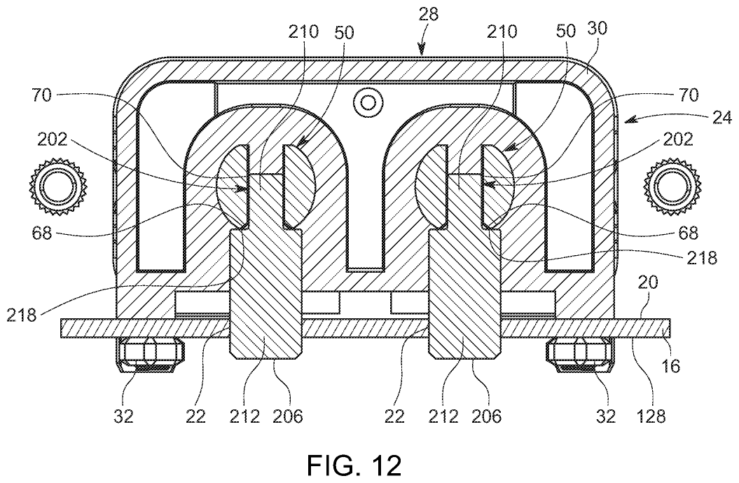

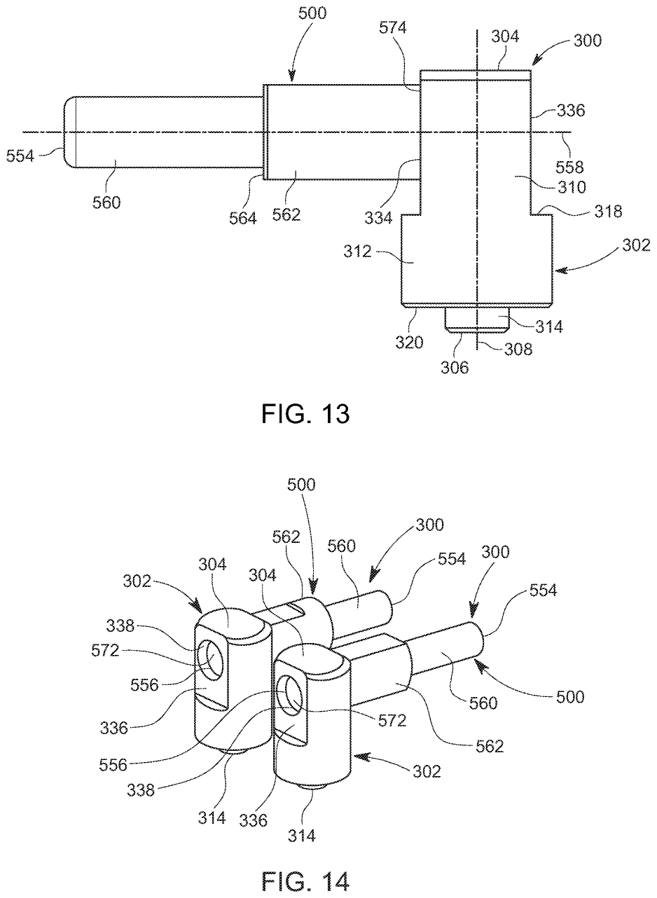

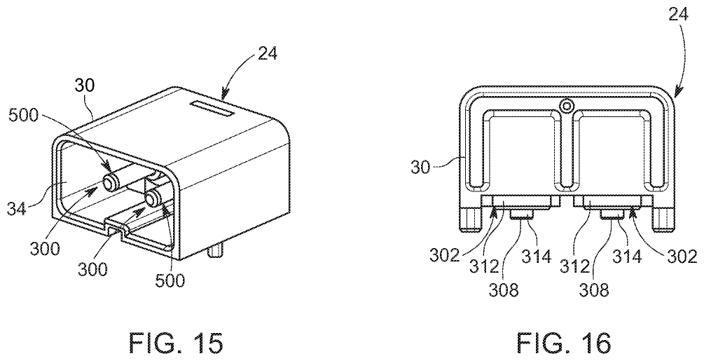

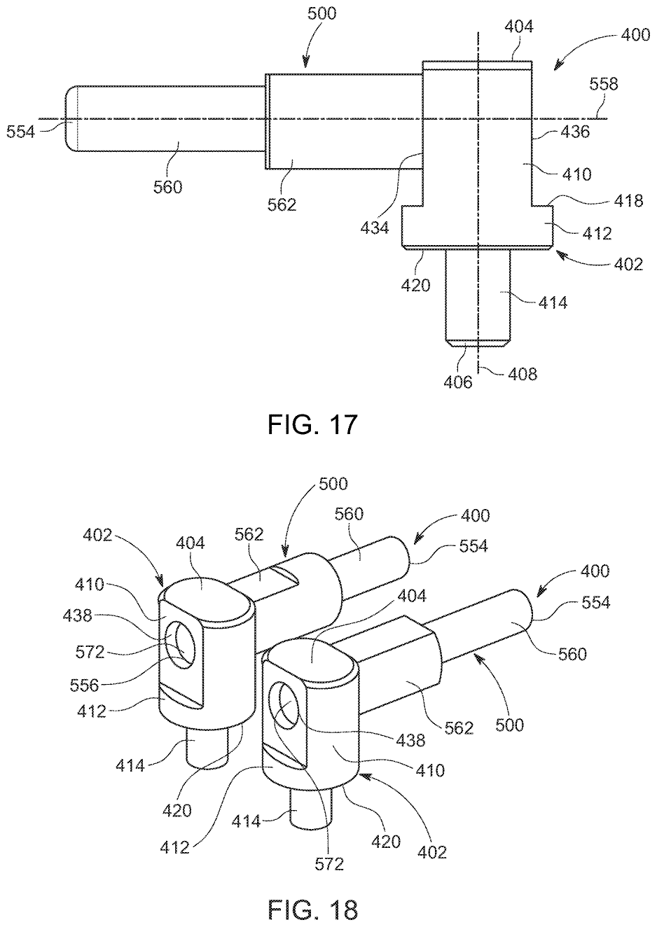

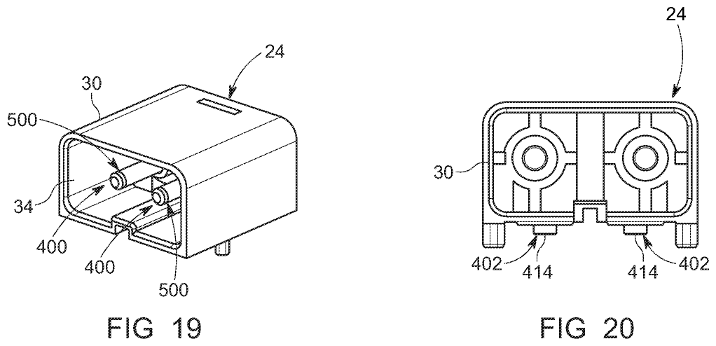

FIGS. 2-7 illustrate a first embodiment of the male terminal 100 and provides for a screw mounting assembly with the circuit board 16. FIGS. 7-12 illustrate a second embodiment of the male terminal 200 and provides for a solder mounting assembly with the circuit board 16. FIGS. 13-16 illustrate a third embodiment of the male terminal 300 and provides for a screw mounting assembly with the circuit board 16. FIGS. 17-20 illustrate a fourth embodiment of the male terminal 400 and provides for a solder mounting assembly with the circuit board 16. In each embodiment, the male terminal 100, 200, 300, 400 is formed of a first pin 50, 500 and a second pin 102, 202, 302, 402 which are joined through an interference fit. By providing a first pin 50, 500 coupled with a separate second pin 102, 202, 302, 402 to form the male terminal 100, 200, 300, 400, flatness and hole true position are optimized. In addition, by providing the first pin 50, 500 coupled with the separate second pin 102, 202, 302, 402 to form the male terminal 100, 200, 300, 400 in the manner described herein, electrical stability is provided. In addition, the problems of material squeezing issue and/or material expansion which resulting from the prior art bending method are eliminated. The use of the interference fit does not impact the electrical performance of the male terminal 100, 200, 300, 400.

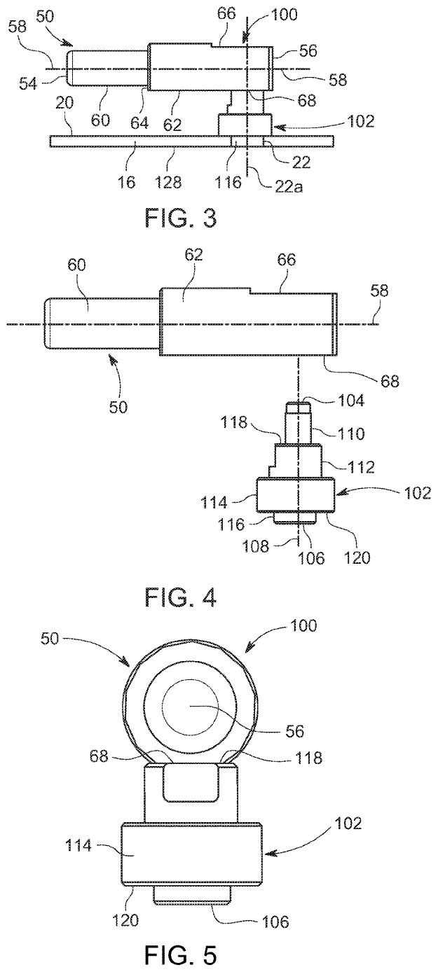

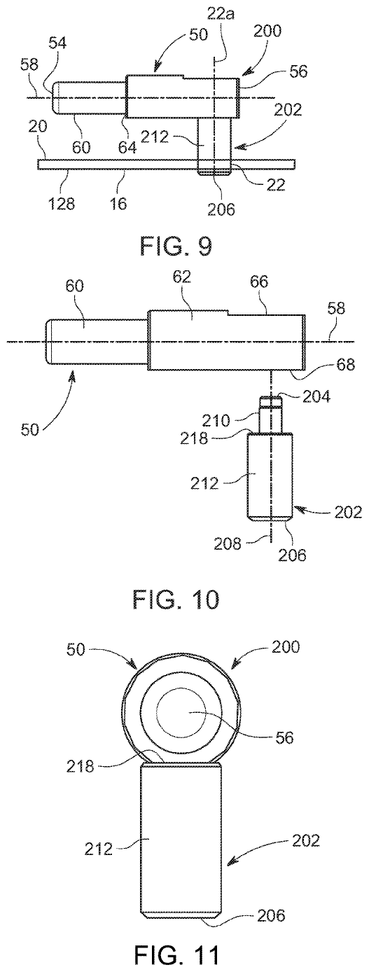

In the embodiments of the male terminal 100 shown in FIGS. 3-5 and the male terminal 200 shown in in FIGS. 9-11, the first pin 50 is formed of an elongated solid rod having opposite first and second ends 54, 56 which define an axial centerline 58 of the rod.

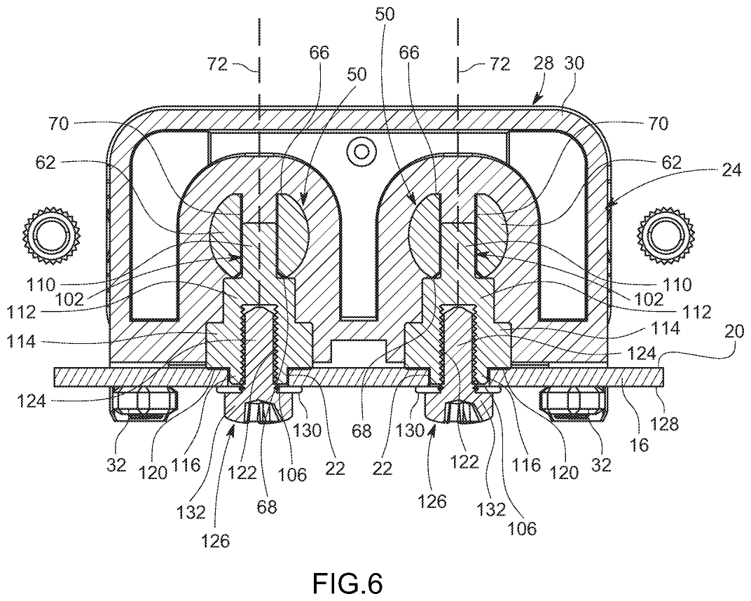

The first pin 50 has a first portion 60, and a second portion 62 extending from an end of the first portion 60. Each portion 60, 62 may be cylindrical. The second portion 62 has a diameter which is greater than the first portion 60 such that a planar wall 64 is formed therebetween by the second portion 62. The second portion 62 has opposite flat wall portions 66, 68 extending from the second end 56 thereof and along a portion of the second portion 62. A socket 70, see FIGS. 6 and 7, is provided through the second portion 62, and in particular through the flat wall portion 68, at a position proximate to, but spaced from, the second end 56. A centerline 72 of the socket 70 is transverse to the centerline 58 of the first pin 50. The socket 70 is unthreaded and has an open lower end to accept the second pin 102 and may have an opposite open end as shown in the drawings. As shown, the socket 70 is cylindrical.

In the first embodiment of the male terminal 100 shown in FIGS. 3-5, the second pin 102 is formed of an elongated solid rod having opposite first and second ends 104, 106 which define an axial centerline 108 therebetween. The second pin 102 has an upper first portion 110, a second portion 112 extending from a lower end of the first portion 110, a third portion 114 extending from a lower end of the second portion 112, and a fourth portion 116 extending from a lower end of the third portion 114. The first portion 110 has a profile that conforms to the profile of the socket 70. Each portion 110, 112, 114, 116 may be cylindrical. The second portion 112 has a diameter which is greater than the first portion 110 such that an upper planar wall 118 is formed therebetween by the second portion 112. The third portion 114 has a diameter which is greater than the fourth portion 116 such that a lower planar wall surface 120 is formed therebetween by the third portion 114. The third portion 114 defines an enlarged portion of the second pin 102. The third portion 114 may have a diameter which is greater than the second portion 112.

The first portion 110 of the second pin 102 forms a mating projection and is seated within the socket 70 of the first pin 50 after assembly. The axial centerline 72 of the socket 70 and the axial centerline 108 of the second pin 102 align. The socket 70 of the first pin 50 and the first portion 110 of the second pin 102 and are sized to ensure a tight press fit of the first portion 110 into the socket 70 to provide the interference fit, and tolerances are tightly controlled to ensure that the centerlines 58, 108 of the pins 50, 102 are perpendicular to each other. The planar wall 118 of the second pin 102 engages the flat wall portion 68 of the first pin 50 and prevents the further entry of the second pin 102 into the socket 70. While the socket 70 and first portion 110 are shown and described as cylindrical, the socket 70 and first portion 110 can have polygonal cross-sections along the lengths thereof.

An internal blind bore 122 is provided in the second pin 102 and extends from the second end 106 of the second pin 102, through the fourth portion 116, the third portion 114 and into the second portion 112. The wall forming the blind bore 122 has an internal thread form provided thereon.

The coupled first and second pins 50, 102 which form the first embodiment of the male terminal 100 are insert molded into the housing 30 to form the header assembly 24. The end 54 of the first pin 50 and a portion of the first portion 60 proximate thereto extend into the cavity 34 and form the wire connecting portion. A portion of the third portion 114 and the fourth portion 116 of the second pin 102 extend downward from the housing 30. The planar wall surface 120 of the third portion 114 is flush with and lays in planar contact with the planar surface 20 of the circuit board 16, and the fourth portion 116 is positioned within the hole 22 through the circuit board 16. The axis 22a of the hole 22 and the centerline 108 of the second pin 102 align. The fourth portion 116 has a diameter which is less than the diameter of the hole 22. A threaded shank 124 of a fastener 126, which may be a screw, is threaded into the blind bore 122 from a second side 128 of the circuit board 16, and a washer 130, which may be a flat washer or a Belleville washer, is positioned between the second side 128 of the circuit board 16 and an enlarged head 132 of the fastener 126. This provides for optimum surface-to-surface contact between the planar wall surface 120 and the planar surface 20 of the circuit board 16.

In the second embodiment of the male terminal 200 shown in FIGS. 9-11, the second pin 202 is formed of an elongated solid rod having opposite first and second ends 204, 206 which define an axial centerline 208 therebetween. The second pin 202 has an upper first portion 210 and a lower second portion 212 extending from a lower end of the first portion 210. The first portion 210 has a profile that conforms to the profile of the socket 70. Each portion 210, 212 may be cylindrical. The second portion 212 has a diameter which is greater than the first portion 210 such that an upper planar wall 218 is formed therebetween by the second portion 212.

Identical to that of the first embodiment of the male terminal 100, the first portion 210 forms a mating projection and is seated within the socket 70 of the first pin 50 after assembly. The axial centerline 72 of the socket 70 and the axial centerline 208 of the second pin 202 align. The socket 70 of the first pin 50 and the first portion 210 of the second pin 202 are sized to ensure a tight press fit of the first portion 210 into the socket 70 to provide the interference fit, and tolerances are tightly controlled to ensure that the centerlines 58, 208 of the pins 50, 202 are perpendicular to each other. The planar wall 218 of the second pin 202 engages the flat wall portion 68 of the first pin 50 and prevents the further entry of the second pin 202 into the socket 70. While the socket 70 and first portion 110 are shown and described as cylindrical, the socket 70 and first portion 210 can have polygonal cross-sections along the lengths thereof.

The coupled first and second pins 50, 202 which form the second embodiment of the male terminal 200 are insert molded into the housing 30 to form the header assembly 24. The end 54 of the first pin 50 and a portion of the first portion 60 proximate thereto extend into the cavity 34 and form the wire connecting portion. A portion of the second portion 212 of the second pin 202 extends downward from the housing 30. A lower portion of the second portion 212 forms a tail portion and is positioned within the hole 22 through the circuit board 16 and may extend below the second side 128 of the circuit board 16. The axis 22a of the hole 22 and the centerline 208 of the second pin 202 align. The diameters of the second portion 212 and the hole 22 are controlled so that an axis-to-axis alignment occurs between the second portion 212 and the hole 22. Thereafter, the second pin 202 is soldered to the circuit board 16.

The two-piece male terminal 100, 200 assists in aligning the male terminal 100, 200 with the hole 22 in the circuit board 16, and assists in achieving correct true positioning of the male terminal 100, 200 relative to the circuit board 16, while mounting the header assembly 24 onto the circuit board 16 and establishing optimum electrical contact after the soldering process is completed.

In the embodiments of the male terminal 300 shown in FIGS. 13 and 14 and the male terminal 400 shown in in FIGS. 17 and 18, the first pin 500 is formed of an elongated solid rod having opposite first and second ends 554, 556 which define an axial centerline 558 therebetween. The first pin 500 has a first portion 560, a second portion 562 extending from an end of the first portion 560, and a third portion 572 extending from an end of the second portion 562. Each portion 560, 562, 572 may be cylindrical. The second portion 562 has a diameter which is greater than the first portion 560 such that a planar wall 564 is formed therebetween by the second portion 562. The second portion 562 has a diameter which is greater than the third portion 572 such that a planar wall 574 is formed therebetween by the second portion 562.

In the third embodiment of the male terminal 300 shown in FIGS. 13 and 14, the second pin 302 is formed of an elongated solid rod having opposite first and second ends 304, 306 which define an axial centerline 308 therebetween. The second pin 302 has an upper first portion 310, a second portion 312 extending from a lower end of the first portion 310, and a third portion 314 extending from a lower end of the first portion 310. Each portion 310, 312, 314 may be cylindrical. The second portion 312 has a diameter which is greater than the first portion 310 such that an upper planar wall 318 is formed therebetween by the second portion 312. The second portion 312 has a diameter which is greater than the third portion 314 such that a lower planar wall surface 320 is formed therebetween by the second portion 312. The second portion 312 defines an enlarged portion of the second pin 302.

The first portion 310 has opposite flat wall portions 334, 336 extending from the upper end 304 thereof and along a portion of the first portion 310. A socket 338 is provided through the first portion 310, and in particular through the flat wall portion 334, at a position proximate to, but spaced from, the upper end 304. A centerline of the socket 338 is transverse to the centerline 308 of the second pin 302. The socket 338 is unthreaded and has an open end to accept the first pin 500 and may have an opposite open end as shown in the drawings. As shown in the drawings, the socket 338 is cylindrical.

The third portion 572 of the first pin 500 has a profile that conforms to the profile of the socket 338 and forms a mating projection which is seated within the socket 338 of the second pin 302 after assembly. The axial centerline of the socket 338 and the axial centerline 558 of the first pin 500 align. The planar wall 574 of the second portion 562 abuts against the flat wall portion 334 and prevents the further entrance of the third portion 572 into the socket 338. The third portion 572 of the first pin 500 and the socket 338 of the second pin 302 are sized to ensure a tight press fit of the third portion 572 into the socket 338 to provide the interference fit, and tolerances are tightly controlled to ensure that the centerlines of the pins 500, 302 are perpendicular to each other. While the socket 338 and the third portion 572 are shown and described as cylindrical, the socket 338 and third portion 572 can have polygonal cross-sections along the lengths thereof.

An internal blind bore (not shown) is provided in the second pin 302 and extends from the second end 306 of the second pin 302, through the third portion 314 and into the second portion 312. In an embodiment, the blind bore does not intersect the socket 338. The wall forming the blind bore has an internal thread form provided thereon.

The coupled first and second pins 500, 302 which form the third embodiment of the male terminal 300 are insert molded into the housing 30 to form the header assembly 24. The end 554 of the first pin 500 and a portion of the first portion 560 proximate thereto extend into the cavity 34 and form the wire connecting portion. A portion of the second portion 312 and the third portion 314 of the second pin 302 extend downward from the housing 30. The planar wall surface 320 of the second portion 312 is flush with and lays in planar contact with the planar surface 20 of the circuit board 16, and the third portion 314 forms a tail portion and is positioned within the hole 22 through the circuit board 16. The axis 22a of the hole 22 and the centerline 308 of the second pin 302 align. The third portion 314 has a diameter which is less than the diameter of the hole 22. The threaded shank 124 of fastener 126 is threaded into the blind bore of the second pin 302 from the second side 128 of the circuit board 16, and the washer 130, which may be a flat washer or a Belleville washer, is positioned between the second side 128 of the circuit board 16 and the enlarged head 132 of the fastener 126. This provides for optimum surface-to-surface contact between the planar wall surface 320 and the planar surface 20 of the circuit board 16.

In the fourth embodiment of the male terminal 400 shown in FIGS. 17 and 18, the second pin 402 is formed of an elongated solid rod having opposite first and second planar ends 404, 406 which define an axial centerline 408 therebetween. The second pin 402 has an upper first portion 410, a second portion 412 extending from a lower end of the first portion 410, and a third portion 414 extending from a lower end of the first portion 410. Each portion 410, 412, 414 may be cylindrical. The second portion 412 has a diameter which is greater than the first portion 410 such that an upper planar wall 418 is formed therebetween by the second portion 412. The second portion 412 has a diameter which is greater than the third portion 414 such that a lower planar wall surface 420 is formed therebetween by the second portion 412. The second portion 412 defines an enlarged portion of the second pin 402.

The first portion 410 has opposite flat wall portions 434, 436 extending from the first upper end 404 thereof and along a portion of the first portion 410. A socket 438 is provided through the first portion 410, and in particular through the flat wall portion 434, at a position proximate to, but spaced from, the first end 404. A centerline of the socket 438 is transverse to the centerline 408 of the second pin 402. The socket 438 is unthreaded and has an open end to accept the first pin 500 and may have an opposite open end as shown in the drawings. The socket 438 may be cylindrical.

The third portion 572 of the first pin 500 forms a mating projection and is seated within the socket 438 of the second pin 402 after assembly. The axial centerline of the socket 438 and the axial centerline 558 of the first pin 500 align. The planar wall 574 of the second portion 562 abuts against the flat wall portion 434 and prevents the further entrance of the third portion 572 into the socket 438. The third portion 572 of the first pin 500 and the socket 438 of the second pin 402 are sized to ensure a tight press fit of the third portion 572 into the socket 438 to provide the interference fit, and tolerances are tightly controlled to ensure that the centerlines of the pins 500, 402 are perpendicular to each other. While the socket 438 and the third portion 572 are shown and described as cylindrical, the socket 438 and third portion 572 can have polygonal cross-sections along the lengths thereof.

The coupled first and second pins 500, 402 which form the fourth embodiment of the male terminal 400 are insert molded into the housing 30 to form the header assembly 24. The end 554 of the first pin 500 and a portion of the first portion 560 proximate thereto extend into the cavity 34 and form the wire connecting portion. A portion of the second portion 412 and the third portion 414 of the second pin 402 extend downward from the housing 30. A lower portion of the third portion 412 forms a tail portion and is positioned within the hole 22 through the circuit board 16 and may extend below the second side 128 of the circuit board 16. The axis 22a of the hole 22 and the centerline 408 of the second pin 402 align. The diameters of the third portion 414 and the hole 22 are controlled so that an axis-to-axis alignment occurs between the third portion 414 and the hole 22. Thereafter, the second pin 402 is soldered to the circuit board 16.

The two-piece male terminal 300, 400 assists in aligning the male terminal 300, 400 with the hole 22 in the circuit board 16, and assists in achieving correct true positioning of the male terminal 300, 400 relative to the circuit board 16, while mounting the header assembly 24 onto the circuit board 16 and establishing optimum electrical contact after the soldering process is completed.

While the two-piece male terminal 100, 200, 300, 400 is shown and described herein as being soldered or fastened to the circuit board 16, the two-piece male terminal 100, 200, 300, 400 may be surface mounted to the circuit board 16.

The two-piece design of each embodiment of the male terminal 100, 200, 300, 400 achieves a 90 degree angle with precise tolerances and without deviation. In addition, high accuracy tolerances enable the overmolding of the male terminal 100, 200, 300, 400 within the header assembly 24.

The use of the terms “a” and “an” and “the” and “at least one” and similar references in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A right angle male terminal of a header assembly of an electrical connector which is configured to be electrically coupled to a wired receptacle of the electrical connector and to a circuit board, comprising:
a first pin comprising an elongated solid conductive rod having first and second opposite ends and defining an axial centerline, the first pin being configured to be electrically coupled to the wired receptacle; and
a second pin comprising an elongated solid conductive rod having first and second opposite ends and defining an axial centerline, the second pin being configured to be electrically coupled to the circuit board,
wherein one of the first and second pins has an unthreaded socket provided therein and the other of the first and second pins has a mating projection, wherein the mating projection and the socket are coupled by an interference fit, and
wherein the axial centerline of the first pin is perpendicular to the axial centerline of the second pin.

2. The male terminal of claim 1, wherein the socket is cylindrical and the mating projection is cylindrical.

3. The male terminal of claim 1, wherein the second pin has a blind bore therein which is configured to receive a threaded screw that passes through the circuit board.

4. The male terminal of claim 3, wherein the first pin has the unthreaded socket therein.

5. The male terminal of claim 3, wherein the second pin has the unthreaded socket therein.

6. The male terminal of claim 1, wherein the second pin has an enlarged portion having a planar lower surface that is configured to seat on the circuit board.

7. The male terminal of claim 1, wherein the second pin is soldered to a through hole of the circuit board.

8. The male terminal of claim 7, wherein the first pin has the unthreaded socket therein.

9. The male terminal of claim 7, wherein the second pin has the unthreaded socket therein.

10. (canceled)

11. An electrical connector for coupling to a circuit board, comprising:
a receptacle having wires coupled thereto; and
a header assembly comprising a housing and a male terminal insert molded into the housing, the male terminal being configured to be coupled to the wires and to the circuit board, the male terminal including:
a first pin comprising an elongated solid conductive rod having first and second opposite ends and defining an axial centerline, the first pin being configured to be electrically coupled to the wire, and
a second pin comprising an elongated solid conductive rod having first and second opposite ends and defining an axial centerline, the second pin being configured to be electrically coupled to the circuit board,
wherein one of the first and second pins has an unthreaded socket provided therein and the other of the first and second pins has a mating projection, wherein the mating projection and the socket are coupled by an interference fit, and
wherein the axial centerline of the first pin is perpendicular to the axial centerline of the second pin.

12. The electrical connector of claim 11, wherein the socket is cylindrical and the mating projection is cylindrical.

13. The electrical connector of claim 11, wherein the second pin is configured to be coupled to the circuit board, the second pin having a blind bore therein which is configured to receive a threaded screw that passes through the circuit board.

14. The electrical connector of claim 13, wherein the first pin has the unthreaded socket therein.

15. The electrical connector of claim 13, wherein the second pin has the unthreaded socket therein.

16. The electrical connector of claim 11, wherein the second pin has an enlarged portion having a planar lower surface that is configured to seat on the circuit board.

17. The electrical connector of claim 11, wherein the second pin is soldered to a through hole of the circuit board.

18. The electrical connector of claim 17, wherein the second pin has the unthreaded socket therein.

19. The electrical connector of claim 17, wherein the second pin has an enlarged portion having a planar lower surface that is configured to seat on the circuit board.

20-27. (canceled)

28. A method of forming a right angle male terminal comprising:
providing a first pin comprising an elongated solid conductive rod having first and second opposite ends and defining an axial centerline, the first pin being configured to be electrically coupled to a wired receptacle; and
providing a second pin comprising an elongated solid conductive rod having first and second opposite ends and defining an axial centerline, the second pin being configured to be electrically coupled to a circuit board; and
inserting a mating projection of one of the first and second pins into an unthreaded socket in the other of the first and second pins and coupling the mating projection and the socket by an interference fit, wherein the axial centerline of the first pin is perpendicular to the axial centerline of the second pin.

29. A method of forming a header assembly comprising:
providing a first pin comprising an elongated solid conductive rod having first and second opposite ends and defining an axial centerline, the first pin being configured to be electrically coupled to a wired receptacle, and
providing a second pin comprising an elongated solid conductive rod having first and second opposite ends and defining an axial centerline, the second pin being configured to be electrically coupled to a circuit board;
inserting a mating projection of one of the first and second pins into an unthreaded socket in the other of the first and second pins and coupling the mating projection and the socket by an interference fit, wherein the axial centerline of the first pin is perpendicular to the axial centerline of the second pin; and
overmolding a housing around the first and second pins.

30. A method comprising:
providing a first pin comprising an elongated solid conductive rod having first and second opposite ends and defining an axial centerline, the first pin being configured to be electrically coupled to a wired receptacle, and
providing a second pin comprising an elongated solid conductive rod having first and second opposite ends and defining an axial centerline;
inserting a mating projection of one of the first and second pins into an unthreaded socket in the other of the first and second pins and coupling the mating projection and the socket by an interference fit, wherein the axial centerline of the first pin is perpendicular to the axial centerline of the second pin;
overmolding a housing around the first and second pins; and
electrically coupling the second pin to a circuit board.

31. (canceled)

32. (canceled)
